(19) United States
(12) Patent Application Publication
(10) Pub. No.: US 2015/0049121 A1
(43) Pub. Date: Feb. 19, 2015

(54) INFORMATION DISPLAY DEVICE, INFORMATION DISPLAY METHOD, AND NON-TRANSITORY STORAGE MEDIUM

(71) Applicant: NEC Corporation, Tokyo (JP)

(72) Inventors: Masahiro KATSUKI, Tokyo (JP); Ryoko INAGE, Tokyo (JP); Takato OZAWA, Tokyo (JP)

(73) Assignee: NEC Corporation, Tokyo (JP)

(21) Appl. No.: 14/384,976

(22) PCT Filed: Dec. 25, 2012
(86) PCT No.: PCT/JP2012/008245

§ 371 Date: Sep. 12, 2014

(30) Foreign Application Priority Data
Mar. 14, 2012 (JP) 2012-057671

(51) Int. Cl. G09G 5/22

(52) U.S. Cl. CPC G09G 5/22
USPC 345/689

(57) ABSTRACT

Provided is an information display device (1) that includes a name storage unit (10) that stores a name of a content, an additional information starting character string storage unit (20) that, when additional information on the content is included in the name of the content, stores one or a plurality of additional information starting character strings which are considered to be starting character strings of the additional information in the name, and a display unit (30) that detects whether an additional information starting character string is included in a first name in the name, and when a string is included, displays a portion of a character string in the first name which includes a character string (additional information beginning character string) having M characters, which starts from the additional information starting character string in the first name, and a character string (body text beginning character string) having N characters from the beginning in the first name, in a name display region on a screen.

### CROSS-REFERENCE TO RELATED PATENT APPLICATIONS

This application is a National Stage Entry of International Application No. PCT/JP2012/008245, filed Dec. 25, 2012, which claims priority from Japanese Patent Application No. 2012-057671, filed Mar. 14, 2012. The entire contents of the above-referenced applications are expressly incorporated herein by reference.

### TECHNICAL FIELD

The present invention relates to an information display device, an information display method, and a program.

### BACKGROUND ART

Each of contents such as a commercial message (CM) is given a name for identifying the content. In many cases, additional information such as a version or a revision history which is important in identifying each content is present in a latter part of the name of the content. For example, “ABCDE bazaar(New Year version)”, “ABCDE bazaar (Setsubun version)”, and the like are examples thereof. In the examples, version information in parentheses corresponds to the additional information.

Incidentally, such a name of the content is displayed on a screen in various scenes, but the number of characters of the name of the content which are capable of being displayed may be limited by the design of the screen. When the number of characters of the name of the content exceeds an upper limit, the entire name of the content cannot be displayed on the screen.

In this case, for example, means of displaying the name from the beginning in a displayable range in sequence (displaying only a portion of a character string from the beginning) is considered. However, in a case of this means, it may not be possible to include the above-described additional information in a portion to be displayed, and thus each content may not be identified from details displayed. For example, when an upper limit of the number of characters capable of being displayed is twelve characters, “ABCDE bazaar” which is a character string of twelve characters from the beginning is displayed in both the two content names described above. In this case, it is not possible to identify each of the two contents from the details displayed.

Patent Document 1 discloses a display device that, when a limitation on the number of characters is set in an area for displaying a file name, creates a display file name including a predetermined number of characters from the beginning of the file name and a predetermined number of characters from the end of the file name so as to correspond to the number of characters capable of being displayed and that displays the display file names.

Patent Document 2 discloses an information display method of, when the entire information cannot be displayed in a predetermined area, displaying a combination of information having a predetermined number of characters from the beginning and information having a predetermined number of characters from the end in the information to be displayed.

### RELATED DOCUMENT

### Patent Document

[Patent Document 1] Japanese Unexamined Patent Publication No. 2009-163561

[Patent Document 2] Japanese Unexamined Patent Publication No. 2007-148674

### DISCLOSURE OF THE INVENTION

When the number of characters of a name of a content exceeds an upper limit of the number of characters capable of being displayed, a character string having a predetermined number of characters from the beginning and a character string having a predetermined number of characters from the end are displayed using the techniques disclosed in Patent Documents 1 and 2, and thus it is possible to display a portion of additional information when the additional information is attached to the end of the name of the content.

However, when a character string having a predetermined number is displayed from the end as in the techniques disclosed in Patent Documents 1 and 2, each content may not be identified from details displayed even when a portion of additional information is able to be displayed. For example, when seven characters from the beginning of a content name and five characters from the end thereof are displayed in a region where an upper limit of the number of characters capable of being displayed is twelve characters, “ABCDE bsion)” is displayed in both the two content names described above. In this case, it is not possible to identify each of the two content names described above from the details displayed.

In addition, for example, when additional information is positioned in the vicinity of an intermediate position of a name of a content instead of being positioned at the end of the name of the content, the additional information cannot be displayed.

Consequently, an object of the present invention is to provide a technique that, when a name of a content which includes additional information exceeds the number of characters capable of being displayed, displays information capable of identifying the content within a range of a limitation on the number of characters.

According to the present invention, provided is an information display device including a name storage unit that stores a name of a content; an additional information starting character string storage unit that stores one or a plurality of additional information starting character strings; and a display unit that detects whether an additional information starting character string stored in the additional information starting character string storage unit is included in the name, and when a string is included, displays a character string including an additional information beginning character string, which is a character string having M characters starting from the additional information starting character string in the name, and a body text beginning character string which is a character string having N characters from the beginning in the name, in a name display region on a screen.

In addition, according to the present invention, also provided is a program for causing a computer to function as: a name storage unit that stores a name of a content; an additional information starting character string storage unit that stores one or a plurality of additional information starting character strings; and a display unit that detects whether an additional information starting character string stored in the additional information starting character string storage unit is included in the name, and when a string is included, displays a character string including an additional information beginning character string, which is a character string having M characters starting from the additional information starting character string in the name, and a body text beginning character string which is a character string having N characters from the beginning in the name, in a name display region on a screen.

In addition, according to the present invention, also provided is an information display method of causing a computer to: store a name of a content and one or a plurality of additional information starting character strings; and execute a display process of detecting whether an additional information starting character string is included in the name, and when a string is included, display a character string including an additional information beginning character string, which is a character string having M characters starting from the additional information starting character string in the name, and a body text beginning character string which is a character string having N characters from the beginning in the name, in a name display region on a screen.

According to the present invention, when a name of a content which includes additional information exceeds the number of characters capable of being displayed, it is possible to display information capable of identifying the content within a range of a limitation on the number of characters.

### BRIEF DESCRIPTION OF THE DRAWINGS

The above-mentioned objects, other objects, features and advantages will be made clearer from preferred exemplary embodiments described below, and the following accompanying drawings.

FIG. 1 shows an example of a functional block diagram of an information display device according to this exemplary embodiment.

FIG. 2 is a flow chart showing an example of a flow of a display process according to this exemplary embodiment.

FIG. 3 is a diagram illustrating operational effects according to this exemplary embodiment.

FIG. 4 is a flow chart showing an example of a flow of a display process according to this exemplary embodiment.

FIG. 5 shows an example of a functional block diagram of an information display device according to this exemplary embodiment.

FIG. 6 is a diagram illustrating operational effects according to this exemplary embodiment.

### DESCRIPTION OF EXEMPLARY EMBODIMENTS

Hereinafter, exemplary embodiments of the present invention will be described with reference to the accompanying drawings.

Meanwhile, a system, a device, and a server according to this exemplary embodiment are realized by an arbitrary combination of hardware and software on the basis of a CPU, a memory, a program loaded into the memory (including a program previously stored in the memory from when shipping out the device and a program downloaded from a storage medium such as a CD, or a server or the like on the Internet) of an arbitrary computer, a storage unit such as a hard disk that stores the program, and an interface for network connection. In addition, those skilled in the art can understand that various modified examples of realizing the method and device can be made.

In addition, functional block diagrams used in describing this exemplary embodiment show function-based blocks rather than hardware-based configurations. In the functional block diagrams, although description is given such that each server and each device are realized by one item of equipment, a realizing unit thereof is not limited thereto. In other words, each device may be configured to be physically or logically separated.

### First Exemplary Embodiment

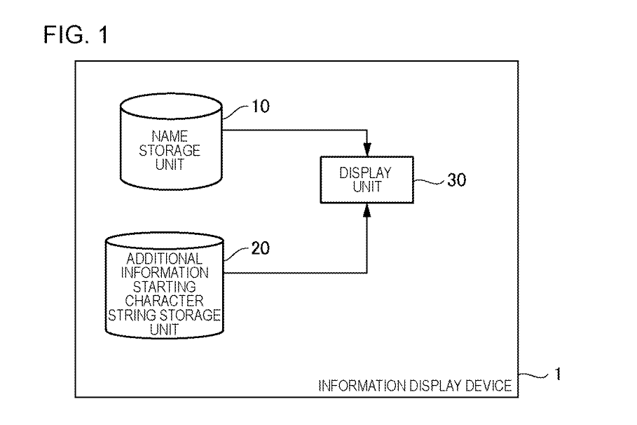

FIG. 1 shows an example of a functional block diagram of an information display device 1 according to this exemplary embodiment. As shown in the drawing, the information display device 1 includes a name storage unit 10, an additional information starting character string storage unit 20, and a display unit 30. Hereinafter, the units will be described.

The name storage unit 10 stores a name of a content. The type of content in this exemplary embodiment is not particularly limited. For example, at least some of a plurality of contents may be grouped by mutually related attributes. As such contents, a CM content including image data and sound data, and the like are considered.

In a case of the CM content, a plurality of variations may be produced on the basis of one concept. For example, as an “ABCDE bazaar” series in which a characteristic character appears, a plurality of variations such as “ABCDE bazaar(New Year version)” or “ABCDE bazaar(Setsubun version)” may be produced. In this manner, as the CM content, a series of contents may be present. In the CM content, the same series of contents may be unified into one group. Meanwhile, the CM content is just an example.

Next, a name of a content may include additional information. In many cases, the additional information may be secondary information for identifying each content.

For example, names of a plurality of contents grouped by mutually related attributes may include information for identifying the group and information (additional information) for identifying the respective contents in the group. In cases of the “ABCDE bazaar (New Year version)” and “ABCDE bazaar (Setsubun version)” described above, the “ABCDE bazaar” is information for identifying the series (group), and the “New Year version” and the “Setsubun version” are additional information for identifying the respective contents in the series (group).

In this manner, for example, the additional information includes a version, a revision history, or the like. Meanwhile, the additional information may be attached to a content which is not grouped. For example, a subtitle of a content or the like may be attached to a name, as additional information. The name storage unit 10 stores one or a plurality of content names.

When a name of a content includes additional information on the content, the additional information starting character string storage unit 20 stores one or a plurality of additional information starting character strings that are considered to be starting character strings of the additional information in the name.

When a name of a content includes additional information, the additional information is often present at an intermediate position or a latter position of the name instead of being positioned at the start in the name, for the reason such as the positioning thereof as secondary information for identifying each content. In order to identify the additional information and information which is present just before the additional information in the name, information for identifying these pieces of information is often present in a start portion of the additional information. The “additional information starting character string” is a character string for identifying additional information and information which is present just before the additional information in a name. In other words, the additional information starting character string is a character string for indicating the start of the additional information in the name. The character string can be one of a character, a number, and a sign or a combination thereof.

For example, the additional information starting character string storage unit 20 may store at least one of an open parenthesis, a space, a half-width character, “#”, “V”, “v”, “Ver”, “ver”, “−”, “@”, “*”, “:”, “″”, “′”, “+”, “·”, “/”, and “˜” as the additional information starting character string. For example, when additional information is indicated by half-width characters and other portions in the name are indicated by full-width characters, the half-width characters may be the additional information starting character string. Meanwhile, these are merely examples, and the additional information starting character string storage unit 20 may store other additional information starting character strings.

The display unit 30 displays predetermined information in a region where a name of a content is displayed in a screen (name display region), using a name stored in the name storage unit 10.

The screen may be a screen which is designed so as to display a name of a content which is stored in the name storage unit 10. For example, the screen may be a screen on which a list of names of a plurality of contents is displayed or may be a screen on which a list of pieces of attribute information of one content (including the name of the content) is displayed. Meanwhile, the name display region is configured such that a maximum number of characters Cmax (positive integer) capable of being displayed is determined in accordance with setting which is determined in advance, the size of the name display region, setting (size, character spacing, and the like) of characters to be displayed in the name display region, and the like.

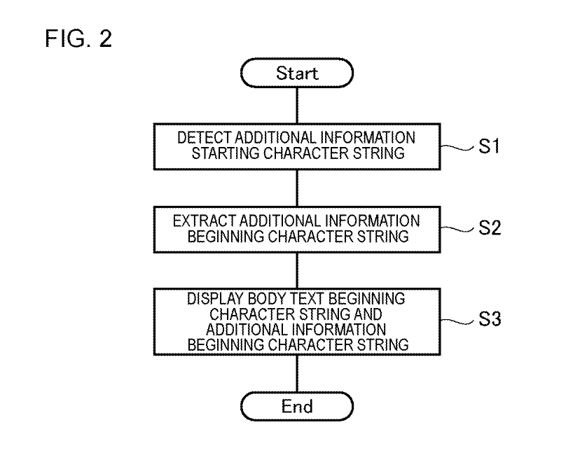

Here, the display unit 30 of this exemplary embodiment can perform the following display process instead of displaying the name stored in the name storage unit 10 in the name display region as it is. An example of a flow of the process will be described below with reference to a flow chart of FIG. 2.

First, when the display unit 30 acquires a name (first name) to be displayed in the name display region from the name storage unit 10, the unit detects whether an additional information starting character string stored in the additional information starting character string storage unit 20 is included in the first name (S1).

When an additional information starting character string is included, the display unit 30 extracts an additional information beginning character string which is a character string having M characters (M is an integer equal to or greater than 1) which starts from the additional information starting character string in the first name (S2). When a plurality of additional information starting character strings are included in the first name, the display unit 30 may extract the character string having M characters (M is an integer equal to or greater than 1) which starts from the additional information starting character string which is displayed first in the first name, as the additional information beginning character string.

Thereafter, a character string (a port ion of a character string in the first name) which includes the additional information beginning character string extracted in S2 and a body text beginning character string which is a character string having N characters (N is an integer equal to or greater than 1) from the beginning in the first name, is displayed in the name display region (S3).

Meanwhile, the display unit 30 performs the above-described display process so that the relation of (M+N)≦Cmax is established. For example, the display unit 30 may previously hold a predetermined constant as M (the number of characters of the additional information beginning character string) and may arbitrarily change N (the number of characters of the body text beginning character string) in a range between equal to greater than 1 and equal to or less than (Cmax−M). For example, N may be set to (Cmax−M).

Alternatively, the display unit 30 may previously hold a predetermined constant as N, and may arbitrarily change M in a range between equal to or greater than 1 and equal to or less than (Cmax−N). For example, M may be set to (Cmax−N). As a specific example of the display process that realizes the relation of (M+N)≦Cmax, for example, the following process examples 1 to 3 are considered. Meanwhile, this exemplary embodiment is not limited thereto.

### Process Example 1

For example, the display unit 30 previously holds a predetermined constant (M<Cmax) as M (the number of characters of the additional information beginning character string), and extracts a character string (additional information beginning character string) having M characters which starts from the additional information starting character string in the first name in S2 of FIG. 2. When the name display region is configured such that a name is displayed in a horizontal direction toward the right from the left, the first name may be displayed in sequence from the beginning in a displayable range within the name display region, and the extracted additional information beginning character string may be displayed in an overlapping manner from above the first name so that the right edge thereof is lined up with a right edge of the name display region (S3).

Meanwhile, when the name display region is configured such that a name is displayed in a vertical direction downwards from above, the first name may be displayed in sequence from the beginning in a displayable range within the name display region, and the extracted additional information beginning character string may be displayed in an overlapping manner from above the first name so that the lower edge thereof is lined up with a lower edge of the name display region (S3).

### Process Example 2

As other examples, the display unit 30 previously holds a predetermined constant (M<Cmax) as M. The display unit 30 sets N in a range between equal to or greater than 1 and equal to or less than (Cmax−M). For example, N is set to (Cmax−M).

Thereafter, a character string (additional information beginning character string) having M characters which starts from the additional information starting character string in the first name and a character string (body text beginning character string) having N characters which starts from the beginning of the first name are extracted, and a character string which is a combination of the extracted body text beginning character string and additional information beginning character string is created and is displayed in the name display region.

As means of acquiring Cmax, for example, when a value of Cmax is determined in advance by the design of a screen, the display unit 30 acquires this value. In addition, when the value of Cmax is determined in accordance with factors such as the size of the name display region and the setting (size, character spacing, and the like) of characters to be displayed in the name display region, the display unit 30 acquires values of the factors and calculates Cmax using the acquired values.

### Process Example 3

In addition, the display unit 30 may previously hold a predetermined constant (N<Cmax) as N. In addition, M may be set in the same manner as the process of setting N in the process example 2, and the character string which is the combination of the body text beginning character string and the additional information beginning character string may be displayed in the name display region in the same manner as in the process example 2.

For example, the display unit 30 may realize the display process in which the relation of (M+N)≦Cmax is established by the above-described process examples 1 to 3.

Meanwhile, the display unit 30 may identifiably display the additional information beginning character string and the body text beginning character string in the name display region. As means of allowing the strings to be identified, for example, when the body text beginning character string and the additional information beginning character string are displayed next to each other in parallel, means of displaying a dotted line or a translucent line or a sign such as a dot therebetween may be considered.

For example, the information display device 1 described above according to this exemplary embodiment can be realized by installing the following program in a computer.

The program causes a computer to function as a name storage unit that stores a name of a content, an additional information starting character string storage unit that stores one or a plurality of additional information starting character strings, and a display unit that detects whether an additional information starting character string stored in the additional information starting character string storage unit is included in the name, and when a string is included, displays a character string including an additional information beginning character string, which is a character string having M characters starting from the additional information starting character string in the name, and a body text beginning character string which is a character string having N characters from the beginning of the name, in a name display region on a screen.

Next, operational effects of this exemplary embodiment will be described.

For example, a case where a content name “ABCDE bazaar(Setsubun version)” is displayed in a name display region (Cmax=12) is considered.

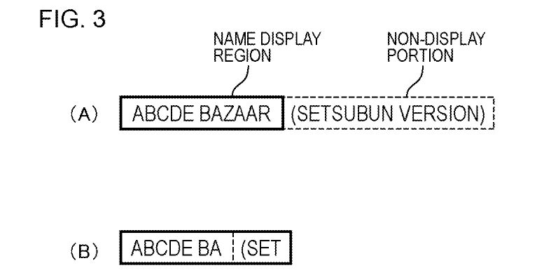

The number of characters of “ABCDE bazaar(Setsubun version)” is 30, and a maximum number of characters Cmax capable of being displayed in the name display region is 12, and thus it is not possible to display the entire name in the name display region. When the name is displayed in sequence from the beginning in a displayable range within the name display region, only “ABCDE bazaar” is displayed as shown in FIG. 3(A), and additional information is not displayed.

On the other hand, in this exemplary embodiment, it is possible to display a character string having a predetermined number of characters from the beginning of a name and a character string having a predetermined number of characters from an additional information starting character string, in a name display region (FIG. 3(B)).

When additional information on a content is included in a name of the content, the additional information starting character string is a character string which is considered to be a starting character string of the additional information in the name. For this reason, a character string having a predetermined number of characters from the additional information starting character string may be a character string having a predetermined number of characters from the beginning of additional information which is present in the name of the content with a high probability. That is, in this exemplary embodiment, it is possible to display a character string having a predetermined number of characters from the beginning of a name and a character string having a predetermined number of characters from the beginning of additional information, in the name display region with a high probability.

According to such an information display device of this exemplary embodiment, when a name of a content which includes additional information exceeds the number of characters capable of being displayed, it is possible to display information (a character string having a predetermined number of characters from the beginning of the name and a character string having a predetermined number of characters from the beginning of the additional information) which allows to identify the content within a range of a limitation on the number of characters.

### Second Exemplary Embodiment

An example of a functional block diagram of an information display device 1 of this exemplary embodiment is similar to that in the first exemplary embodiment (FIG. 1). Meanwhile, the information display device 1 of this exemplary embodiment is different from that in the first exemplary embodiment in the configuration of a display unit 30. The configurations of other units are the same as those in the first exemplary embodiment.

When the number of characters of a name (first name) to be displayed in a name display region on a screen is equal to or less than Cmax (a maximum number of characters capable of being displayed in the name display region), the display unit 30 of this exemplary embodiment displays the first name in the name display region as it is. On the other hand, when the number of characters of the first name exceeds Cmax, the unit displays a character string including an additional information beginning character string and a body text beginning character string in the name display region, as described in the first exemplary embodiment.

As described in the first exemplary embodiment, the screen may be designed so as to display a name of a content which is stored in a name storage unit 10. For example, the screen may be a screen on which a list of names of a plurality of contents is displayed or may be a screen on which a list of pieces of attribute information of one content (including a name of a content) is displayed. When a display unit 30 displays an arbitrary name among names of contents which are stored in the name storage unit 10 in a name display region, the unit can confirm whether the number of characters is equal to or less than Cmax (a maximum number of characters capable of being displayed in the name display region) for each name, can display a first name in the name display region as it is in accordance with a result of the confirmation, or can display a character string including an additional information beginning character string and a body text beginning character string in the name display region.

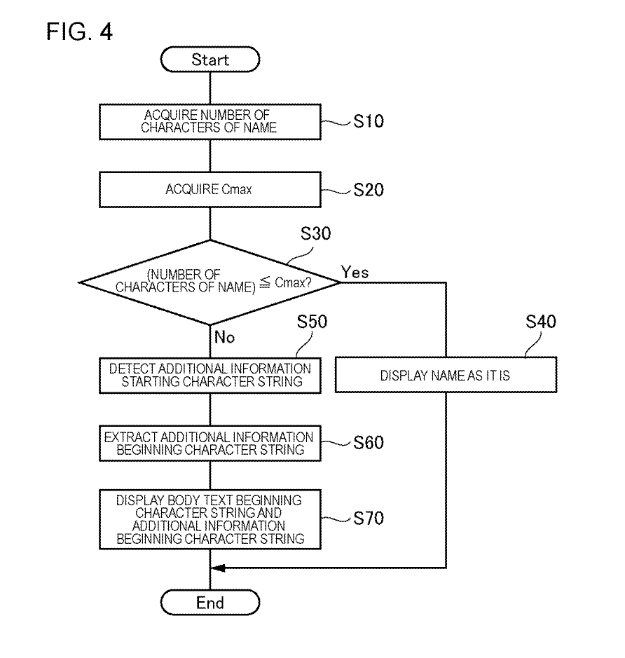

An example of a flow of a display process using the display unit 30 of this exemplary embodiment will be described below with reference to a flow chart of FIG. 4.

First, when the display unit 30 acquires a name (first name) to be displayed in a name display region from the name storage unit 10, the unit acquires (for example, calculates) the number of characters of the first name (S10).

In addition, the display unit 30 acquires (for example, calculates) a maximum number of characters Cmax capable of being displayed in the name display region (S20).

For example, when a value of Cmax is determined in advance by the design of a screen, the display unit 30 may acquire the value. In addition, when the value of Cmax is determined in accordance with factors such as the size of the name display region and the setting (size, character spacing, and the like) of characters to be displayed in the name display region, the display unit 30 may acquire values of the factors and may calculate Cmax using the acquired values.

Meanwhile, the order of the processes of S10 and S20 may be reversed.

Thereafter, the display unit 30 determines whether the number of characters of the first name is equal to or less than Cmax (S30). When the number of characters of the first name is equal to or less than Cmax (Yes in S30), the display unit 30 displays the first name in the name display region as it is (S40). On the other hand, when the number of characters of the first name exceeds Cmax (No in S30), processes of S50 to S70 are executed. Meanwhile, the processes of S50 to S70 are the same as the processes of S1 to S3 of FIG. 2 which are described in the first exemplary embodiment. Thus, the description thereof will be omitted here.

As described above, according to the information display device of this exemplary embodiment, it is possible to display preferred information in identifying a content in a name display region in accordance with a numerical relation between a maximum number of characters capable of being displayed in the name display region and the number of characters of a name to be displayed.

### Third Exemplary Embodiment

An information display device 1 of this exemplary embodiment basically has the configurations of the information display devices 1 according to the first and second exemplary embodiments, and further has anew function to be described below.

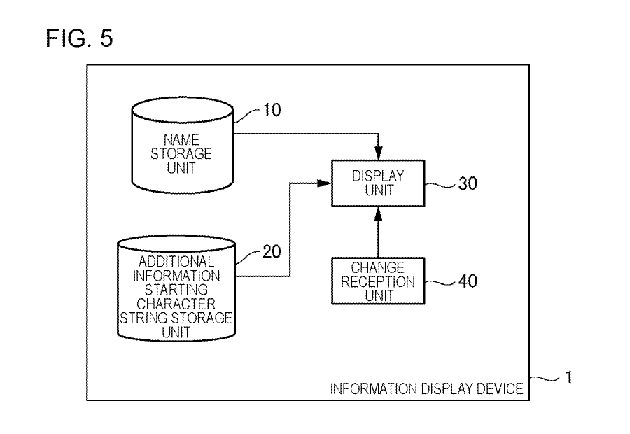

An example of a functional block diagram of the information display device 1 of this exemplary embodiment is shown in FIG. 5. As shown in the drawing, the information display device 1 includes a name storage unit 10, an additional information starting character string storage unit 20, a display unit 30, and a change reception unit 40. Hereinafter, the display unit 30 and the change reception unit 40 will be described. Meanwhile, the configurations of the name storage unit 10 and the additional information starting character string storage unit 20 are the same as those in the first and second exemplary embodiments, and thus the description thereof will be omitted here.

The change reception unit 40 receives an input for changing a maximum number of characters Cmax capable of being displayed in a name display region. The input for changing Cmax is different depending on the design of the name display region.

For example, a value of Cmax may be determined in advance by the design of a screen, and when the value is designed to be changeable, an input for changing the value corresponds to the input for changing Cmax.

On the other hand, the value of Cmax may be determined in accordance with factors such as the size of the name display region and the setting (size, character spacing, and the like) of characters to be displayed in the name display region, and when the values of the factors are designed to be changeable, an input for changing the values of the factors corresponds to the input for changing Cmax.

The change reception unit 40 receives the above-described input for changing Cmax from a user through any input device such as a keyboard, a mouse, an input button, a touch panel display, or a microphone.

When the change reception unit 40 receives the input for changing Cmax, the display unit 30 changes at least one of M (the number of characters of an additional information beginning character string) and N (the number of characters of a body text beginning character string) in response to the change in Cmax, and performs setting so that M+N becomes equal to or less than the changed Cmax. A character string including a character string (additional information beginning character string) having M characters which starts from an additional information starting character string in a first name and a character string (body text beginning character string) having N characters which starts from the beginning in the first name is displayed in the name display region in accordance with the values of M and N after the setting.

For example, such a display process can also be realized using any one of the process examples 1 to 3 described in the first exemplary embodiment. In cases of the process examples 1 to 3, one constant (M or N) which is determined in advance is not changed, and only the other is changed in response to the change in Cmax.

Meanwhile, the following process can be adopted as another display process. In a case of the process example, both M and N can be changed.

For example, the display unit 30 previously holds Mmax (positive integer) which is a maximum value of M and a constant T (T>0) for determining M×T which is a minimum value of N.

When the relation of (Mmax+Mmax×T)≦Cmax is established, that is, when the sum of the maximum value of M and the minimum value of N is equal to or less than Cmax, the display unit 30 sets M to Mmax and sets N to be in a range between equal to or greater than (Mmax×T) and equal to or less than (Cmax−Mmax), for example, (Cmax−Mmax).

On the other hand, when the relation of (Mmax+Mmax×T)>Cmax is established, that is, when the sum of the maximum value of M and the minimum value of N is greater than Cmax, the display unit 30 sets M to a value satisfying the relation of (M×T+M)≦Cmax, for example, a maximum value satisfying the relation of (M×T+M)≦Cmax, and sets N to Cmax−M.

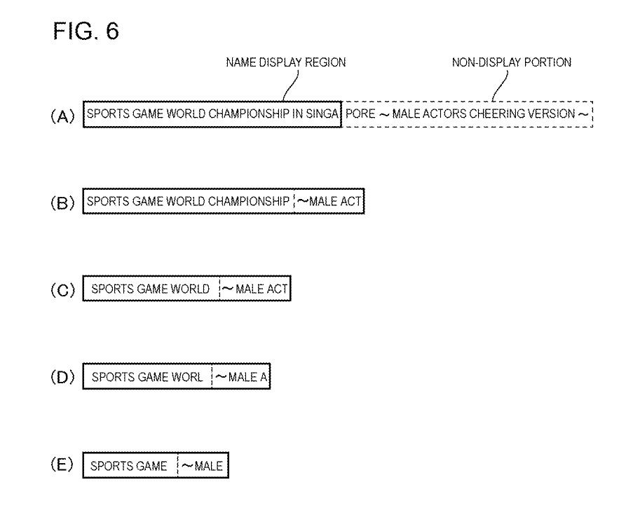

The display process will be described below with reference to FIG. 6.

In the example, a content name “sports game world championship in Singapore-male actors cheering version-” is displayed in a name display region. In FIG. 6(A) and FIG. 6(B), Cmax is set to 39.

The number of characters of the name is 73 and the maximum number of characters Cmax capable of being displayed in the name display region is 39, and thus it is not possible to display the entire name in the name display region as shown in FIG. 6(A). When the name is displayed in sequence from the beginning in a displayable range within the name display region, only “sports game world championship in Singa” is displayed as shown in the drawing, and additional information is not displayed.

In this case, the display unit 30 of this exemplary embodiment displays a character string having a predetermined number of characters from the beginning of the name and a character string having a predetermined number of characters from an additional information starting character string as shown in FIG. 6(B). Meanwhile, it is assumed that Mmax which is the maximum value of M is set to 9 and the constant T (T>0) for determining M×T which is the minimum value of N is set to 2.

When Cmax is 39, the relation of (Mmax+Mmax×T)≦Cmax is satisfied. For this reason, the display unit 30 sets M to 9(=Mmax) and sets N to, for example, 30(=Cmax−Mmax). In addition, the display unit displays a character string including a body text beginning character string having 30 characters and an additional information beginning character string having 9 characters in the name display region. Meanwhile, after M is set, the display shown in FIG. 6(B) may be realized by a process which is the same as that in the process example 1 described in the first exemplary embodiment (the same applies hereinafter).

Thereafter, the change reception unit 40 receives an input for changing Cmax, and thus Cmax is assumed to be set to 27. Also in this case, the relation of (Mmax+Mmax×T)≦Cmax is satisfied. For this reason, the display unit 30 sets M to 9(=Mmax) and sets N to 18(=Cmax−Mmax). As shown in FIG. 6(C), a character string including a body text beginning character string having 18 characters and an additional information beginning character string having 9 characters is displayed in a name display region.

Thereafter, the change reception unit 40 receives an input for changing Cmax, and thus Cmax is assumed to be set to 23. In this case, the relation of (Mmax+Mmax×T)>Cmax is established. For this reason, the display unit 30 sets M to a value satisfying the relation of (M×T+M)≦Cmax, for example, 7 which is a maximum value satisfying the relation of (M×T+M)≦Cmax, and sets N to 16 (=Cmax−M). As shown in FIG. 6(D), a character string including a body text beginning character string having 16 characters and an additional information beginning character string having 7 characters is displayed in a name display region.

Thereafter, the change reception unit 40 receives an input for changing Cmax, and thus Cmax is assumed to be set to 17. In this case, the relation of (Mmax+Mmax×T)>Cmax is established. For this reason, the display unit 30 sets M to a value satisfying the relation of (M×T+M)≦Cmax, for example, 5 which is a maximum value satisfying the relation of (M×T+M)≦Cmax, and sets N to 12 (=Cmax−M). As shown in FIG. 6 (E), a character string including a body text beginning character string having 12 characters and an additional information beginning character string having 5 characters is displayed in a name display region.

In the example, even when the maximum number of characters Cmax capable of being displayed in the name display region is changed, it is possible to maintain a display state where the number of characters of the body text beginning character string is equal to or greater than a predetermined multiple of the number of characters of the additional information beginning character string. That is, it is possible to maintain an appropriate balance (N is equal to or greater than T times M) between the number of characters N of the body text beginning character string and the number of characters M of the additional information beginning character string.

According to the above-described information display device of this exemplary embodiment, it is possible to realize operational effects which are the same as those in the first and second exemplary embodiments. In addition, according to the information display device of this exemplary embodiment, when a maximum number of characters capable of being displayed in a name display region is changed, it is possible to change the number of characters of at least one of a body text beginning character string and an additional information beginning character string in accordance with the changed maximum number of characters, and to display information capable of identifying a content concerned within a range of a limitation on the number of characters. In addition, it is possible to maintain an appropriate balance (N is equal to or greater than T times M) between the number of characters N of the body text beginning character string and the number of characters M of the additional information beginning character string.

### Fourth Exemplary Embodiment

An information display device 1 of this exemplary embodiment basically has the configurations of the information display devices 1 according to the first, second, or third exemplary embodiment, and further has a new function to be described below.

An example of a functional block diagram of the information display device 1 of this exemplary embodiment is the same as those in the first to third exemplary embodiments (FIG. 1 or FIG. 5). Meanwhile, the information display device 1 of this exemplary embodiment is different from those in the first to third exemplary embodiments in the configuration of a display unit 30. The configurations of other units are the same as those in the first to third exemplary embodiments.

When the number of characters of a first name to be displayed in a name display region exceeds a maximum number of characters Cmax capable of being displayed in the name display region and the first name does not include an additional information starting character string, the display unit 30 of this exemplary embodiment replaces a body text end character string which is a character string having M characters from the end in the first name with an additional information beginning character string and performs the above-described display process.

For example, when the number of characters of the first name to be displayed in the name display region exceeds the maximum number of characters Cmax capable of being displayed in the name display region and the first name does not include an additional information starting character string, the display unit 30 displays a portion of a character string in the first name which includes the body text end character string, which is a character string having M characters from the end in the first name, and the body text beginning character string which is a character string having N characters from the beginning in the first name, in the name display region in a screen.

According to the above-described information display device of this exemplary embodiment, it is possible to realize operational effects which are the same as those in the first to third exemplary embodiments. In addition, according to the information display device of this exemplary embodiment, when an additional information starting character string is not included in a first name to be displayed in a name display region, a character string having a predetermined number of characters from the end in the first name is displayed, and thus it is possible to display a portion of additional information.

The application is based on Japanese Patent Application No. 2012-57671 filed on Mar. 14, 2012, the content of which is incorporated herein by reference.

1. An information display device comprising:
a name storage unit that stores a name of a content;
an additional information starting character string storage unit that stores one or a plurality of additional information starting character strings; and
a display unit that detects whether an additional information starting character string stored in the additional information starting character string storage unit is included in the name, and when the string is included, displays a character string including an additional information beginning character string, which is a character string having M characters starting from the additional information starting character string in the name, and a body text beginning character string which is a character string having N characters from the beginning in the name, in a name display region on a screen.

2. The information display device according to claim 1, wherein the additional information starting character string storage unit stores at least one of an open parenthesis, a space, a half-width character, #, V, v, Ver, ver, −, @, *, :, ″, ′, +, ·, /, and ˜, as the additional information starting character string.

3. The information display device according to claim 1, wherein M which is the number of characters of the additional information beginning character string and N which is the number of characters of the body text beginning character string are determined so that M+N becomes equal to or less than a maximum number of characters Cmax capable of being displayed in the name display region.

4. The information display device according to claim 3, wherein the display unit displays the name in the name display region as it is when the number of characters of the name is equal to or less than Cmax, and displays a character string including the additional information beginning character string and the body text beginning character string in the name display region when the number of characters of the name exceeds Cmax.

5. The information display device according to claim 3, further comprising a change reception unit that receives an input for changing Cmax,
wherein the display unit changes at least one of M and N in accordance with the change in Cmax and performs setting so that M+N becomes equal to or less than Cmax after the change.

6. The information display device according to claim 5, wherein the display unit previously holds Mmax which is a maximum value of M and a constant T (T>0) for determining M×T which is a minimum value of N, sets M to Mmax when a relation of (Mmax+Mmax×T)≦Cmax is established, and sets N to be in a range between equal to or greater than (Mmax×T) and equal to or less than (Cmax−Mmax).

7. The information display device according to claim 6, wherein when a relation of (Mmax+Mmax×T)>Cmax is established, the display unit sets M to a value satisfying the relation of (M×T+M)≦Cmax and sets N to Cmax−M.

8. The information display device according to claim 1, wherein when the display unit displays the character string including the additional information beginning character string and the body text beginning character string in the name display region, the unit identifiably displays the additional information beginning character string and the body text beginning character string.

9. The information display device according to claim 1, wherein when the number of characters of the name exceeds Cmax and the additional information starting character string is not included in the name, the display unit replaces the additional information beginning character string with a body text end character string which is a character string having M characters from the end in the name, and performs a display process.

10. The information display device according to claim 1, wherein the content is a commercial message (CM) content including image data and sound data.

11. A non-transitory storage medium storing a program for causing a computer to function as:
a name storage unit that stores a name of a content;
an additional information starting character string storage unit that stores one or a plurality of additional information starting character strings; and
a display unit that detects whether an additional information starting character string stored in the additional information starting character string storage unit is included in the name, and when a string is included, displays a character string including an additional information beginning character string, which is a character string having M characters starting from the additional information starting character string in the name, and a body text beginning character string which is a character string having N characters from the beginning in the name, in a name display region on a screen.

12. An information display method of causing a computer to:
store a name of a content and one or a plurality of additional information starting character strings; and
execute a display process of detecting whether an additional information starting character string is included in the name, and when a string is included, display a character string including an additional information beginning character string, which is a character string having M characters starting from the additional information starting character string in the name, and a body text beginning character string which is a character string having N characters from the beginning in the name, in a name display region on a screen.
